(19) United States
(12) Patent Application Publication
(10) Pub. No.: US 2010/0166964 A1
(43) Pub. Date: Jul. 1, 2010

(54) METHOD FOR ATTACHING MICRO BUBBLE ARRAY ON PLATE SURFACE

(75) Inventors: Jeung Sang Go, Busan (KR); Moon Jeong Kim, Busan (KR); Bong Hyun Kwon, Busan (KR)

Correspondence Address: LEE, HONG, DEGERMAN, KANG & WAIMEY, 660 S. FIGUEROA STREET, Suite 2300, LOS ANGELES, CA, 90017, US

(73) Assignee: PUSAN NATIONAL UNIVERSITY INDUSTRY UNIVERSITY COOPERATION FOUNDATION

(21) Appl. No.: 12/563,043

(22) Filed: Sep. 18, 2009

(30) Foreign Application Priority Data
Dec. 26, 2008 (KR) 10-2008-0134480

(51) Int. Cl. B05D 5/08

(52) U.S. Cl. 427/290; 264/232; 264/129

(57) ABSTRACT

The present invention relates to a method for attaching a micro bubble array on a plate surface, and more particularly, to a method for attaching micro-sized bubbles on a plate surface so as to reduce fluid frictional resistance caused by flow on the plate surface that encounters with liquid.

The method for attaching a micro bubble array on a plate surface according to one aspect of the present invention includes a micro groove forming step and a hydrophobic treatment step. In the micro groove forming step, a plurality of grooves with a size of 1 to 1,000 micrometers are formed in a plate surface to be arranged therein. In the hydrophobic treatment step, the plate surface having the grooves formed therein is coated with a material having a hydrophobic property. Since the plate surface has the plurality of grooves arranged therein and also is treated with a hydrophobic material, micro bubbles are formed on the micro grooves when the plate surface goes under water.

According to the present invention, the fluid frictional resistance may be reduced using slide occurring between air bubbles and liquid by forming micro bubbles on a plate surface.

### CROSS REFERENCE TO RELATED APPLICATIONS

Pursuant to 35 U.S.C. §119(a), this application claims the benefit of earlier filing date and right of priority to Korean Application No. 10-2008-0134480 filed on Dec. 26, 2008, the contents of which are hereby incorporated by reference herein in their entirety.

### FIELD OF THE INVENTION

The present invention relates to a method for attaching a micro bubble array on a plate surface, and more particularly, to a method for attaching micro-sized bubbles on a plate surface so as to reduce fluid frictional resistance caused by flow on the plate surface that encounters with liquid.

### DESCRIPTION OF THE RELATED ART

Bubbles each having diameter of micrometer (μm) order size are used in various fields depending on their sizes. For example, bubbles having a size of 10 to 40 μm are used for biological activities, bubbles having a size of 40 to 100 μm are used for fluid physics, and bubbles having a size of 500 to 1000 μm are used for decreasing resistance of a ship.

Particularly, in marine transport vehicles, the study on reducing fluid frictional resistance is considered as a next-generation technology for reducing energy with a high efficiency, which may cope with the global warming and the environmental contamination. Also, this technology is actively studied in developed countries such as the United States, Europe and Japan in order to strengthen their competitiveness against Korea that rises as a top country over Japan in the field of ship construction and marine industries.

Fluid frictional resistance occurring between fluid and solid due to flow may minimize energy loss in fluid transport using transportation machines, hydraulic machines, tubes and the like as well as ships, thereby providing additional effects such as improved energy efficiency and reduced fluid noise.

For the reduction of fluid frictional resistance, compliant wall, air injection, riblets polymer injection and the like are representatively studied. In addition, solid surface vibration techniques using electromagnetism or supersonic waves are also studied.

Upon estimating propulsive force generated from a unit weight of the muscle of a dolphin, required for swimming, it was found that the dolphin gives power about 7 times of a human or a mammal living on the land. The compliant wall was developed in the consideration that rapid swimming of a dolphin is possible by virtue of the skin tissues of the dolphin. After that, Kramer made an artificial dolphin skin using a thin elastic rubber film, and then he covered the artificial skin on a swimming body and then measured resistance, which was found as being reduced by 60% at maximum. However, other studies following Kramer did not give any result supporting the Kramer's consideration, so that the studies on that field have been depressed.

The air injection is a method for decreasing frictional resistance by injecting bubbles near a surface of an object. According to recent studies, it was reported that as the amount of injected bubbles is increased, the frictional resistance is more reduced and resistance could be reduced by 80% at maximum. Thus, the air injection is much spotlighted.

The reblet is a means for changing a systematical structure of flow to reduce frictional resistance and is implemented by forming small grooves a wall in a flow direction of fluid. Resistance is effectively decreased only when depth and width of grooves are smaller than a certain criterion. If depth and width of the grooves are greater than a certain criterion, resistance is rather increased. The frictional resistance can be reduced by 8% at maximum. In order to apply such riblets to airplanes or ships, it is needed to deeply examine arrangement of grooves and effects caused by damaged surface. Particularly, in case of ships, optimal depth or width of such grooves is about 0.1 mm, and with a current technology, it is very difficult to solve problems with their production and preventive measures of adhesion of ocean microorganisms to the grooves and the like.

The polymer injection is a method of coating a plate surface with a polymer to reduce frictional resistance due to a surface-active effect. It is known that a polymer solution can greatly reduce frictional resistance at a low concentration of several ppm to several tens of ppm. The polymer injection however has drawbacks in that it causes environmental pollution and its resistance reducing effect rapidly disappears due to the deterioration of polymer function.

### SUMMARY OF THE INVENTION

In the aforementioned techniques for reducing fluid frictional resistance, the air injection allowing production and control to be easy is actively studied in or out of the country so as to enhance the possibility of practical use in the future.

In the United States, the fluid frictional resistance reduction is recognized as a military technology, and since 2000, Defense Advanced Research Projects Agency (DARPA) has studied various techniques together with research centers and related universities with systemic supports for the reduction of frictional resistance over 50%, and the results of such studies are handled as a secret and not opened to the public.

In Japan, research institutes and industries concentrically invest research funds and secure fluid frictional resistance reduction techniques in order to preoccupy an essential highly value-added technique for the purpose of creating a blue ocean market in the future as a past powerful ship construction country.

Korea is evaluated as a beginner in the field of fluid frictional resistance reduction, and basic researches on low-speed resistance reduction by using riblets or polymer attachment are under progress at Korea Advanced Institute of Science and Technology (KAIST) and Pohang University of Science and Technology (POSTECH). Also, Korean Ocean Research & Development Institute and Hyundai Heavy Industries have launched development of a fluid frictional resistance reduction technique using injection of micro bubbles.

However, although the frictional resistance reduction technique using air injection is most actively studied due to easy manufacture and control, it has very serious problems such as reduction of a propulsive force caused by bubbles transferred to a propeller, bad stability of a ship due to unbalanced buoyancy distribution, increased corrosion of a propeller caused by generation of cavitations, and surface corrosion caused by air bubbles containing oxygen.

An object of the present invention is to provide a method for attaching a micro bubble array to a plate surface, by which it is possible to solve complicated problems such as reduction of propulsive force caused by air injection, corrosion caused by cavitations and external devices required for air injection at a time and to spontaneously generate micro bubbles on a surface as desired at desired locations at the instant of going under water.

According to one aspect of the present invention, there is provided a method for attaching a micro bubble array on a plate surface, which comprises a micro groove forming step and a hydrophobic treatment step. In the micro groove forming step, a plurality of grooves with a size of 1 to 1,000 micrometers are formed in a plate surface to be arranged therein. In the hydrophobic treatment step, the plate surface having the grooves formed therein is coated with a material having a hydrophobic property. Since the plate surface has the plurality of grooves arranged therein and also is treated with a hydrophobic material, micro bubbles are formed on the micro grooves when the plate surface goes under water.

According to another aspect of the present invention, there is also provided a method for attaching a micro bubble array on a plate surface, which comprises a micro hole forming step and an air pressure providing step. In the micro hole forming step, a plurality of through holes having a size of 1 to 1,000 micrometers are formed in a plate surface to communicate with a pressing portion and to be arranged in the plate surface. In the air pressure providing step, air pressure is supplied to the plurality of through holes from the pressing portion.

Also, the method for attaching a micro bubble array on a plate surface may further comprise a hydrophobic treatment step for coating the plate surface having the through holes formed therein with a material having a hydrophobic property after the micro hole forming step.

### BRIEF DESCRIPTION OF THE DRAWINGS

FIG. 1 is a schematic diagram illustrating a method for attaching a micro bubble array on a plate surface according to one embodiment of the present invention.

FIG. 2 is a schematic view showing the plate surface to which the embodiment of FIG. 1 is applied.

FIG. 3 is a sectional view showing the plate surface of FIG. 2, which goes under water.

FIG. 4 is a schematic diagram illustrating a method for attaching a micro bubble array on a plate surface according to another embodiment of the present invention.

FIG. 5 is a schematic view showing the plate surface to which the embodiment of FIG. 4 is applied.

FIG. 6 is a sectional view showing the plate surface of FIG. 5, which goes under water.

FIG. 7 shows results of numerical analysis of the method for attaching a micro bubble array on a plate surface according to the present invention.

### DESCRIPTION OF THE PREFERRED EMBODIMENTS

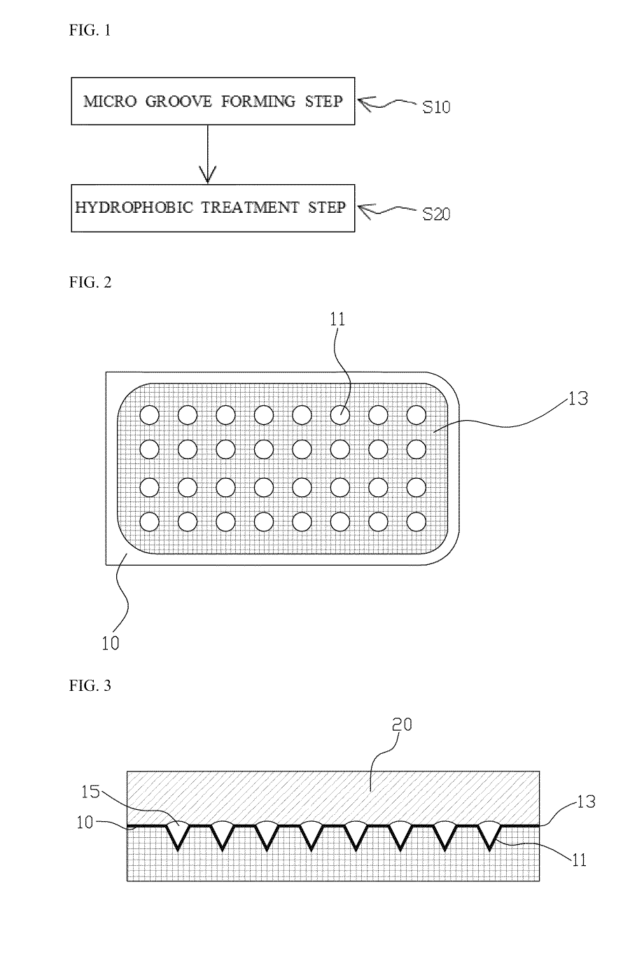

FIG. 1 is a schematic diagram illustrating a method for attaching a micro bubble array on a plate surface according to one embodiment of the present invention; FIG. 2 is a schematic view showing the plate surface to which the embodiment of FIG. 1 is applied; and FIG. 3 is a sectional view showing the plate surface of FIG. 2, which goes under water.

A method for attaching a micro bubble array on a plate surface according to one embodiment of the present invention will be described with reference to FIGS. 1 to 3.

The method for attaching a micro bubble array on a plate surface comprises a micro groove forming step S10 and a hydrophobic treatment step S20.

In the micro groove forming step S10, grooves 11 with a size of 1 to 1,000 μm are formed in a plate surface 10 to be arranged thereon. The groove 11 has a cross section of various shapes, such as quadrangle, triangle, trapezoid and circle.

In the hydrophobic treatment step S20, the plate surface 10 having the grooves 11 is coated with a material having a hydrophobic property. The hydrophobic treatment step S20 causes a hydrophobic surface layer 13 to be formed in the plate surface 10. The hydrophobic treatment on the surface may be achieved using chemicals, polymer, metal or the like.

If the plate surface 10 goes under water 20, bubbles 15 are formed on the grooves 11 of the plate surface 10. The bubbles 15 reduce friction between the plate surface 10 and the water 20.

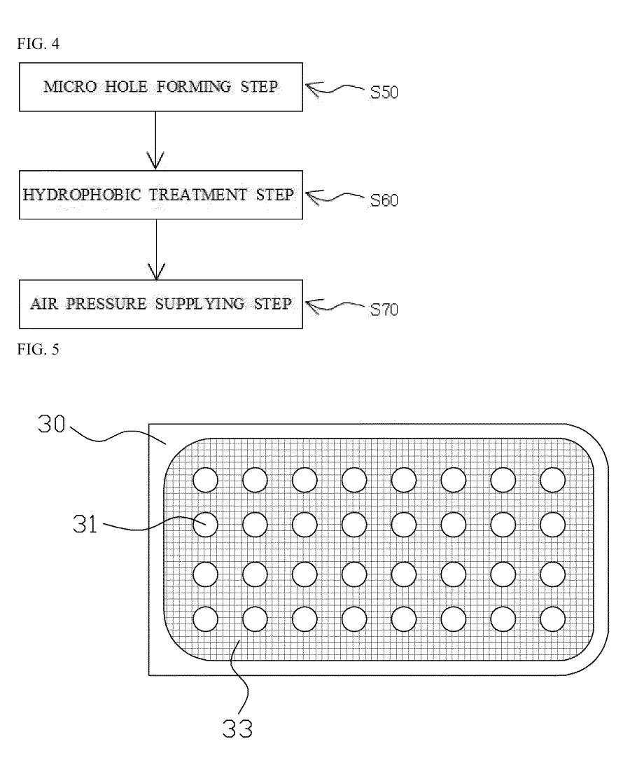

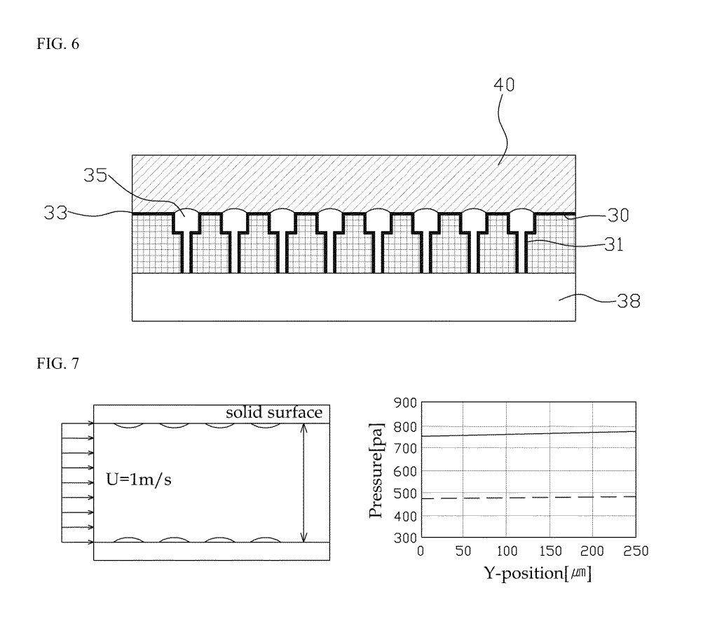

FIG. 4 is a schematic diagram illustrating a method for attaching a micro bubble array on a plate surface according to another embodiment of the present invention; FIG. 5 is a schematic view showing the plate surface to which the embodiment of FIG. 4 is applied; and FIG. 6 is a sectional view showing the plate surface of FIG. 5, which goes under water. A method for attaching a micro bubble array on a plate surface according to another embodiment of the present invention will be described with reference to FIGS. 4 to 6.

The method for attaching a micro bubble array on a plate surface according to this embodiment comprises a micro hole forming step S50, a hydrophobic treatment step S60 and an air pressure providing step S70.

In the micro hole forming step S50, through holes 31 having a size of 1 to 1,000 μm are formed in a plate surface 30 to communicate even with a pressing portion 38 and to be arranged in the plate surface. The through hole 31 allows the plate surface 30 to communicate with the pressing portion 38, and 11 has a cross section of various shapes, such as quadrangle, triangle, trapezoid and circle.

In the hydrophobic treatment step S60, the plate surface 30 having the through holes 31 is coated with a material having a hydrophobic property. The hydrophobic treatment step S60 causes a hydrophobic surface layer 33 to be formed on the plate surface 30.

In the air pressure providing step S70, certain air pressure is supplied to the plurality of through holes 31 from the pressing portion 38.

If the plate surface 30 goes under water 40, bubbles 35 are generated from the through holes 31. In the embodiment illustrated in FIG. 1, if the plate surface 10 goes under water even to a location with high hydraulic pressure, the size of the bubbles 15 is reduced due to the hydraulic pressure, so that the bubbles 15 may be inserted into the grooves 11 or even destroyed in a severe case. In this case, fluid frictional resistance is not reduced by bubbles, so that the fluid frictional resistance reduction effect may not be sufficient if this embodiment is applied to an object going under deep waters. However, in the embodiment illustrated in FIG. 4, the pressing portion 38 provides certain air pressure, so that the bubbles may not be destroyed but maintained although the hydraulic pressure is increased to a high level. Thus, the embodiment shown in FIG. 4 may be usefully applied to reduce the fluid frictional resistance of an object going under deep waters.

FIG. 7 shows results of numerical analysis of the method for attaching a micro bubble array on a plate surface according to the present invention. In order to confirm the possibility of fluid frictional resistance reduction using the attachment of micro bubbles to a surface, the 2-dimensional numerical analysis was performed to Volume of fluid(VOF). In a case where a channel has a height of 500 μm and micro bubbles arranged have a diameter of 100 μm, as a result of comparing the pressures required at an inlet flow rate of 1 m/s, fluid frictional resistance was reduced by 40% or more when the bubbles exist.

According to the present invention, the fluid frictional resistance may be reduced using slide occurring between air bubbles and liquid by forming micro bubbles on a plate surface.

In addition, the present invention may be applied not only to the fluid frictional resistance reducing technique but also to various fields such as a removal of gas generated during chemical reaction of a fuel cell, transportation of specific samples using air bubbles in a bioengineering field, and an optical splitter using air bubbles in an IT field.

What is claimed is:

1. A method for attaching a micro bubble array on a plate surface, comprising:
a micro groove forming step for forming a plurality of grooves having a size of 1 to 1,000 micrometers in a plate surface to be arranged thereon; and
a hydrophobic treatment step for coating the plate surface having the grooves formed therein with a material having a hydrophobic property.

2. A method for attaching a micro bubble array on a plate surface, comprising:
a micro hole forming step for forming a plurality of through holes having a size of 1 to 1,000 micrometers in a plate surface to communicate with a pressing portion and to be arranged in the plate surface; and
an air pressure providing step for supplying air pressure to the plurality of through holes from the pressing portion.

3. The method as claimed in claim 2, further comprising a hydrophobic treatment step for coating the plate surface having the through holes formed therein with a material having a hydrophobic property after the micro hole forming step.
